(19) United States
(12) Patent Application Publication
(10) Pub. No.: US 2024/0334502 A1
(43) Pub. Date: Oct. 3, 2024

(54) TERMINAL DEVICE AND NON-TRANSITORY COMPUTER-READABLE RECORDING MEDIUM THEREFOR

(71) Applicant: BROTHER KOGYO KABUSHIKI KAISHA, Nagoya (JP)

(72) Inventor: Hiroshi SHIBATA, Yatomi (JP)

(21) Appl. No.: 18/621,645

(22) Filed: Mar. 29, 2024

(30) Foreign Application Priority Data
Mar. 31, 2023 (JP) 2023-057220

(51) Int. Cl. H04W 76/10; G06F 3/04847; G06K 7/14; H04M 1/72406

(52) U.S. Cl. CPC H04W 76/10; G06K 7/1417; H04M 1/72406; G06F 3/04847

(57) ABSTRACT

A terminal device includes a display and a controller. The controller is configured to perform obtaining identification information of a target product before installing a setting program, installing the setting program in the terminal device, starting the setting program, and providing the identification information to the setting program. The setting program further causes the display to display a setting screen presenting a setting operation to set the target product. The setting operation indicates one or both of an operation of the target product and an operation of the terminal device. Then, the setting program sets the target product based on the setting operation.

### REFERENCE TO RELATED APPLICATIONS

This application claims priority from Japanese Patent Application No. 2023-057220 filed on Mar. 31, 2023. The entire content of the priority application is incorporated herein by reference.

### BACKGROUND ART

The present disclosure relates to a terminal device and a non-transitory computer-readable recording medium containing compute-executable instructions to set up a target product.

In order to use products such as a printer and a scanner, various settings are performed. For example, in order to establish a wireless connection with an access point, connection information including SSID and password is set. In a conventional art, the connection information is transmitted to a device using an application of a terminal. Here, a sticker indicating a QR code (registered trademark) including a model name of the device is attached to a housing of the device. A user takes a picture of the QR code of the device using a camera of the terminal, then an OS (operating system) of the terminal program decodes the QR code to obtain the model name and supplies the model name to the application. The application displays an operation screen associated with the model name.

### SUMMARY

According to the conventional art described above, when the application for setting the target device is not installed in the terminal, there may be a burden on the user to set up the target product.

According to aspects of the present disclosure, there is provided a terminal device including a display, and a controller. The controller is configured to perform obtaining identification information related to a target product before installing a setting program used to set the target product, installing the setting program in the terminal device, starting the setting program installed in the terminal device, providing the identification information to the setting program causing the display to display a setting screen associated with the identification information, the setting screen presenting a setting operation to set the target product, the setting operation indicating one or both of an operation of the target product and an operation of the terminal device, and setting the target product based on the setting operation.

According to aspects of the present disclosure, there is provided a non-transitory computer-readable recording medium for a terminal device including a display and a controller, the non-transitory computer-readable recording medium containing computer-executable instructions realizing a setting program of the terminal device. The setting program is configured to be installed in the terminal device according to an installation instruction by a user, the installation instruction including an operation of an item included in a web page displayed on the display, the web page being indicated by link information including identification information related to a target product. The setting program is configured to, when executed by the controller, cause the terminal device to perform obtaining the identification information in response to starting the setting program after installation of the setting program, and causing the display to display a setting screen associated with the identification information, the setting screen presenting a setting operation to set the target product, the setting operation including one or both of an operation of the target product and an operation of the terminal device.

### BRIEF DESCRIPTION OF DRAWINGS

FIG. 1 shows a system.

FIG. 2 is a sequence diagram showing an example of the setup process.

FIG. 3 is a sequence diagram showing an example of the setup process.

FIG. 4 is an example of a reference screen.

FIGS. 5A and 5B show examples of link information.

FIGS. 6A-6C show examples of screens displayed on a display.

FIG. 7 shows an example of a screen displayed on the display.

FIG. 8 is a sequence diagram showing another example of the setup process.

### DESCRIPTION

### A1. System Configuration

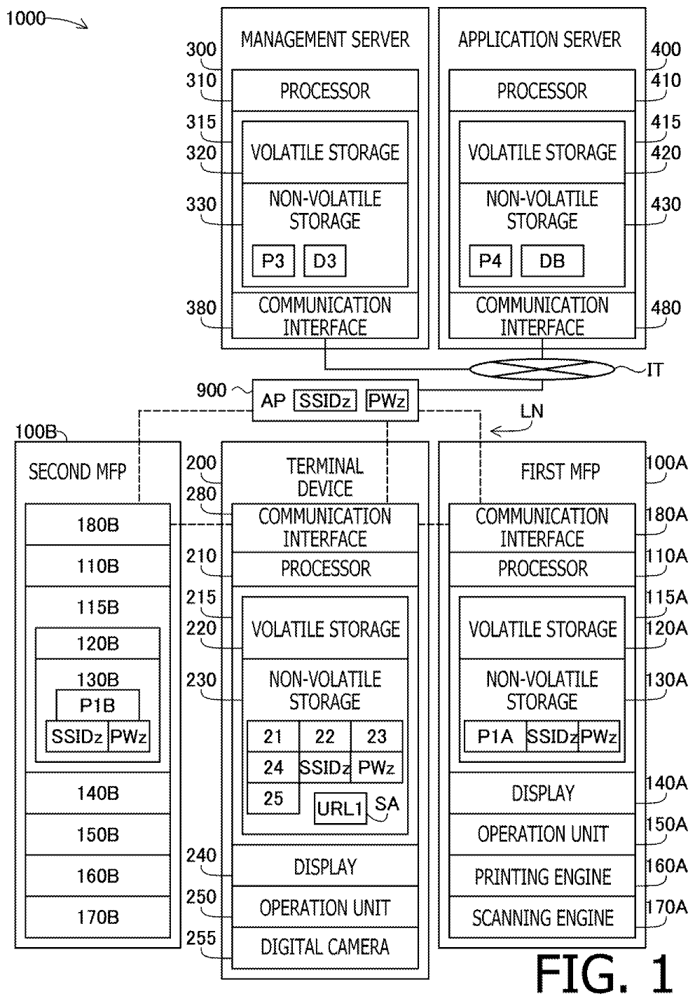

FIG. 1 illustrates a system of an embodiment according to aspects of the disclosure.

The system 1000 includes a first multifunction peripheral (first MFP) 100A, a second multifunction peripheral (second MFP) 100B, a terminal device 200, a management server 300, an application server 400, and a wireless access point 900 (also referred to simply as an access point 900). The management server 300, application server 400 and access point 900 are connected to the Internet IT. The access point 900 forms a wireless local area network LN. A storage (not shown in figures) of the access point 900 stores data of information SSIDz and PWz assigned to the local area network LN. The SSIDz indicates a Service Set Identifier (SSID) and the PWz indicates a password. The terminal device 200 is connected to the local area network LN.

The first MFP 100A and the second MFP 100B and the terminal device 200 (e.g., a smartphone, tablet computer, or the like) are managed by a user. The terminal device 200 is connectable to the first MFP 100A and the second MFP 100B. The user operates the terminal device 200 to configure various settings of the first MFP 100A and the second MFP 100B. For example, the user configures wireless settings (e.g., SSID and password settings) to connect the first MFP 100A and the second MFP 100B to the access point 900 via the terminal device 200. A setting application for the first MFP 100A and the second MFP 100B is used for the settings. The management server 300 provides web pages to support in installation of the setting application. The application server 400 provides the setting application.

The hardware configuration of the first MFP 100A and the second MFP 100B will be described below. In this embodiment, models are different between the first MFP 100A and the second MFP 100B. However, the first MFP 100A and the second MFP 100B have similar hardware configurations. The first MFP 100A and the second MFP 100B have processors 110A, 110B, storages 115A, 115n, displays 140A, 140B, controllers 150A, 150B, printing engines 160A, 160B, scanning engine 170A, 170B, and communication interfaces 180A, 180n, respectively. In each of the MFPs 100A and 100B, these components are connected to each other via buses (not shown in figures).

The displays 140A and 140B are devices configured to display images, such as liquid crystal displays, organic EL displays, and the like. The controllers 150A and 150B are devices configured to receive operations by the user, such as buttons, levers, and touch screens superimposed on the displays 140A and 140n, respectively. In this embodiment, the controller 150A of the first MFP 100A includes a touchscreen panel. The controller 150B of the second MFP 100B does not include a touchscreen panel but includes a plurality of physical buttons. The communication interfaces 180A and 180B are interfaces configured to communicate with other devices. The communication interfaces 180A and 180B include an IEEE 802.11 wireless LAN interface. In this embodiment, the communication interfaces 180A and 180B are connectable to the local area network LN. The communication interfaces 180A and 180B are also communicable with other devices (e.g., the terminal device 200) by working as an access point.

The printing engines 160A and 160B are devices that print images. In this embodiment, the printing engines 160A and 160B are so-called inkjet printers (devices that print images by other methods, such as laser printers, may be employed). The scanning engines 170A and 170B are configured to optically scan an object, such as a document, and generate scan data representing the scanned object.

The processors 110A and 110B are devices configured to process data. The processors 110A and 110B are, for example, a central processing unit (CPU) or a System on a chip (SoC). The storages 115A and 115B include volatile storages 120A and 120B and non-volatile storages 130A and 130B, respectively. For example, the volatile storages 120A and 120B are DRAMs, and the non-volatile storages 130A and 130B are flash memories.

The non-volatile storages 130A and 130B store programs P1A and P1B, respectively. The processes performed by the processors 110A and 110B according to the programs P1A and P1B include processes of controlling the printing engines 160A and 160B and the scanning engines 170A and 170B, processes of communicating with other devices through the communication interfaces 180A and 180B, and processes of setting the MFPs 100A and 100B, respectively. Through a setting process described below, the data of the SSIDz and the PWz are stored in the non-volatile storages 130A and 130B.

Next, the hardware configuration of the terminal device 200 will be described. In this example, the terminal device 200 has a processor 210, a memory 215, a display 240, an operation unit 250, a digital camera 255, and a communication interface 280. These components are connected to each other via a bus (not shown in figures).

The display 240 is a device configured to display images, such as an LCD or organic EL display. The operation unit 250 is a device configured to receive operations by a user, such as buttons, levers, and a touch screen superimposed over the display 240. The digital camera 255 is a device configured to generate image data of an object by photographing the object. The communication interface 280 is an interface configured to communicate with other devices. In this embodiment, the communication interface 280 includes an IEEE 802.11 wireless LAN interface. In this embodiment, the communication interface 280 is connectable to the local area network LN and the MFPs 100A and 100B.

The processor 210 is a device, e.g., a CPU or SoC, configured to process data. The memory 215 includes a volatile storage 220 and a non-volatile storage 230. For example, the volatile storage 220 is a DRAM and the non-volatile storage 230 is a flash memory.

The non-volatile storage 230 stores data for the respective programs of an operating system 21, a camera application 22, a browser 23, a store application 24, and a setting application 25.

The operating system 21 (also referred to simply as OS 21) may be an operating systems, such as Android (registered trademark), iOS (registered trademark), or the like.

The camera application 22 (also referred to as the camera APP 22) has a function of causing the digital camera 255 to capture an object and a function of decoding a code image included in the captured image.

The browser 23 communicates with the web server to display web pages provided by the web server on the display 240.

The store application 24 (also referred to as the store APP 24) manages applications on the terminal device 200. The store application 24 downloads application data from the application server 400 according to a user instruction, and uses the downloaded application data to install an application in the terminal device 200.

The setting application 25 (also referred to as the setting APP 25) sets up the first MFP 100A and the second MFP 100n.

In this embodiment, the OS 21, the camera application 22, the browser 23, and the store application 24 are incorporated into terminal device 200 at the time of manufacture (i.e., before shipment). The setting application 25 is installed according to a user instruction.

Hereinafter, it is assumed that the terminal device 200 has completed the wireless setting to connect the terminal device 200 to the local area network LN. The non-volatile storage 230 stores the data with SSIDz and PWz. The link information SA is stored in the non-volatile storage 230 by the setting process described below.

Next, hardware configurations of the servers 300 and 400 will be described. In this example, the servers 300 and 400 have similar hardware configurations. The servers 300 and 400 have processors 310 and 410, storages 315 and 415, and communication interfaces 380 and 480, respectively. In each server, these components are connected to each other via a bus (not shown in figures).

The communication interfaces 380 and 480 are interfaces configured to communicate with other devices. Each communication interface 380 and 480 includes one or more interfaces, for example, a wired LAN, an IEEE 802.11 wireless LAN. Each communication interface 380 and 480 is connected to the Internet IT. The processors 310 and 410 are devices configured to process data, e.g., CPUs or SoCs. The storages 315 and 415 include volatile storages 320 and 420 and non-volatile storages 330 and 430, respectively. For example, the volatile storages 320 and 420 are DRAMs, and the non-volatile storages 330 and 430 are flash memories.

The non-volatile storage 330 of the management server 300 stores data of a program P3 and data web information D3. The web information D3 represents various web pages. The processor 310 transmits data of the web pages corresponding to a request from an external device to the external device according to the program P3. The management server 300 is operated by a developer of the setting application 25.

The non-volatile storage 430 of the application server 400 stores data of a programs P4 and data of a database DB. The data of the database DB includes data for each of a plurality of applications, including the setting application 25. The processor 410 transmits the data of the applications corresponding to the request from the external device to the external device according to the program P4.

The application server is prepared for each operating system of the terminal device. The application server may be operated by a system operator that provides the corresponding operating system. The application server may provide a product page, which is a web page including a description of the application, in addition to the application data. Hereinafter, it is assumed that the application server 400 corresponds to the operating system 21 of the terminal device 200.

### A2. Setting Process

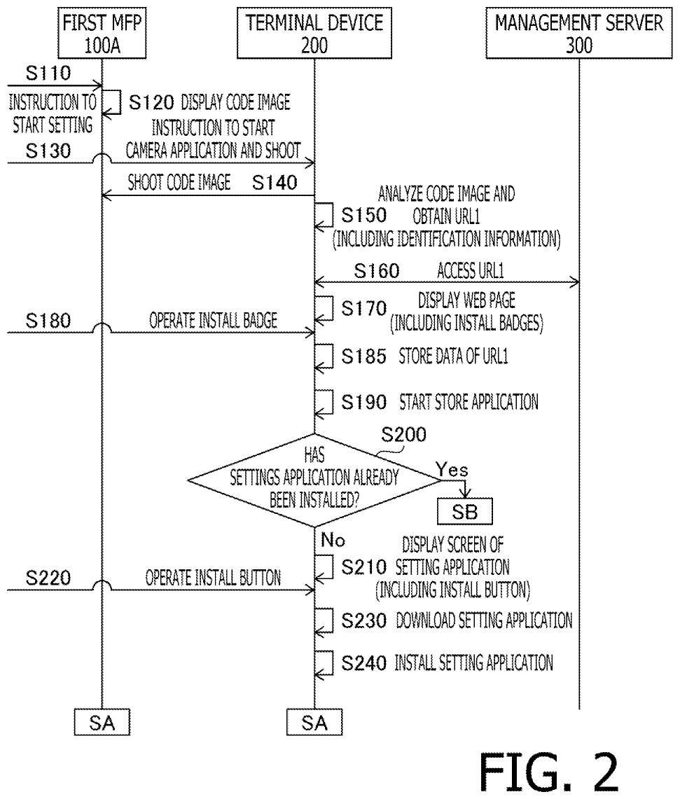

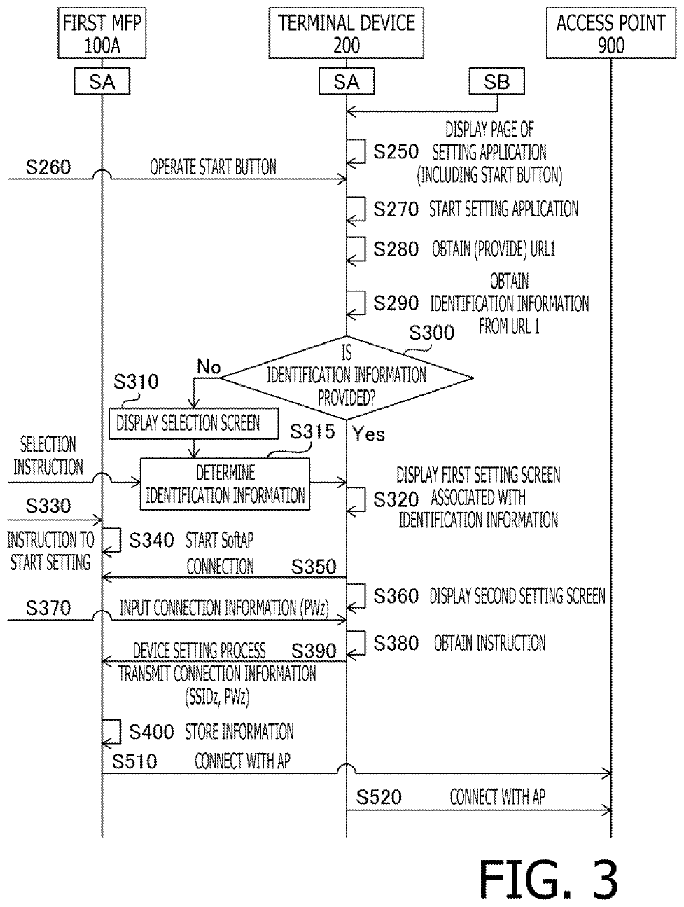

FIGS. 2 and 3 are a sequence diagram showing examples of the setting process. FIG. 3 is a continuation of FIG. 2. In the following, it is assumed that the user performs setting of the first MFP 100A. The processing of the first MFP 100A is performed by the processor 110A according to the program P1A. The processing of the management server 300 is performed by processor 310 according to the program P3. The processing of the terminal device 200 is performed by processor 210 according to various programs 21, 22, 23, 24, 25. Hereafter, in the processes in the terminal device 200, “the processor 210 performs processes” is also expressed as “the corresponding program (e.g., the camera application 22) performs the processes.”

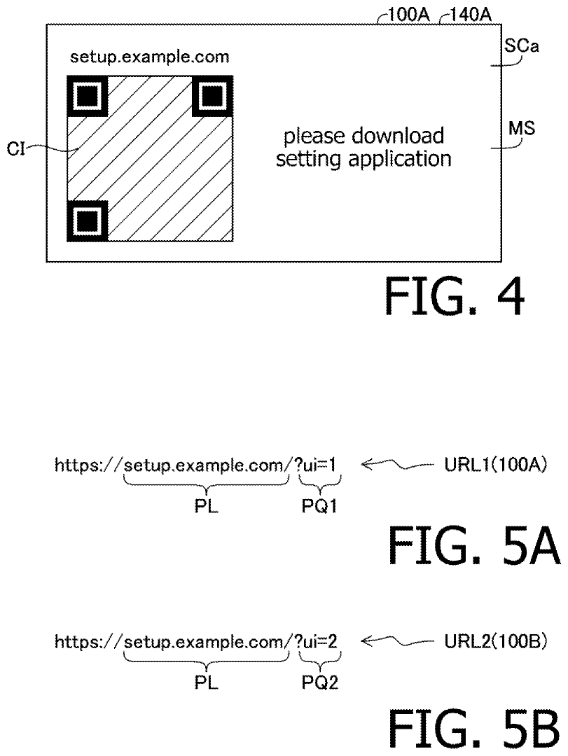

In S110, the user inputs an instruction to the first MFP 100A to start setting by operating the controller 150A. In S120, the processor 110A of the first MFP 100A displays a reference screen on the display 140A in response to the setting instruction. FIG. 4 shows an example of the reference screen. In this embodiment, the reference screen SCa represents a code image CI and a message MS. The code image CI is, for example, a QR code and represents a Uniform Resource Locator (URL) for settings. As described below, this URL indicates a web page that supports in the installation of the setting application 25. The message MS prompts the user to download the setting application 25. The URL represented by the code image CI is hereinafter referred to as link information. The web page represented by the link information is also referred to as a support page.

FIGS. 5A and 5B show examples of link information. FIG. 5A shows an example of first link information provided by the MFP 100A. The first link information URL1 (also referred to simply as the first link URL1) includes a scheme (e.g., “http”, “https”, etc.), location information PL indicating the network location of the web page, and a query PQ.

The location information PL includes a name of the web server in the network (e.g., host name or IP address). The location information PL may further include a path indicating the web page. In this embodiment, the location information PL indicates a web page on the management server 300.

The query PQ represents a value of the key ui. For the first link URL1, the key ui is set to “1.” FIG. 5B shows an example of second link information provided by the second MFP 100B (also referred to simply as the second link URL2). Unlike the first link URL1 (FIG. 5A), in the second link URL2, the key ui is set to “2” instead of “1.” Thus, the key ui indicates models of MFPs 100A and 100B. The key ui is an example of identification information associated with an MFP. Hereafter, the key ui is also referred to as identification information ui. The location information PL is the same regardless of the model.

In S130 (FIG. 2), the user starts the camera application 22 by operating the operation unit 250 of the terminal device 200. The user inputs a shooting instruction by operating the operation unit 250 of the terminal device 200 in a state where the digital camera 255 faces the display 140A (FIG. 4). In S140, the camera application 22 causes the digital camera 255 to shoot the display 140A (FIG. 4) and obtains data of the captured image. In S150, the camera application 22 analyzes the code image CI included in the captured image and obtains link information (in this case, the first link URL1). The analysis of the code image CI (i.e., obtaining of the link information) may be performed by the OS 21 instead of the camera application 22.

In S160, the camera application 22 provides the link information (in this case, the first link URL1) to the browser 23. The browser 23 accesses the management server 300 according to the first link URL1. The browser 23 obtains the data of the web page corresponding to the first link URL1 from the management server 300. The browser 23 may be activated according to the user's instructions. For example, the camera application 22 displays the first link URL1 on the display 240. The user operates the first link URL1 via the operation unit 250. The browser 23 may be started and the first link URL1 may be provided to the browser 23. Alternatively, the browser 23 may be automatically started by the camera application 22 and the operating system 21.

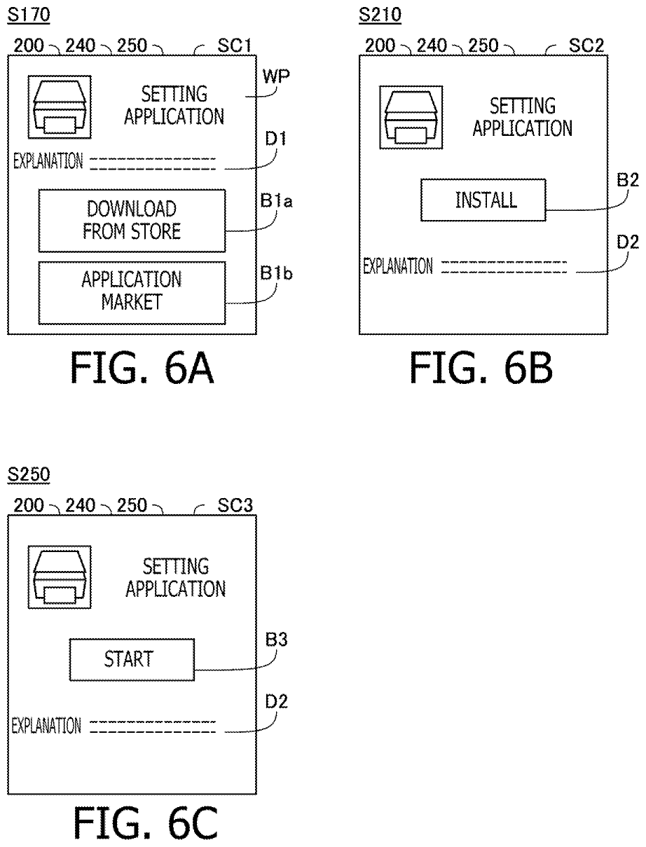

In S170, the browser 23 displays a web page on the display 240 using the data obtained from the management server 300. FIGS. 6A-6C show examples of screens displayed on the display 240. FIG. 6A shows an example of the screen displayed at S170. This screen SC1 represents a web page WP (i.e., a support page). The web page WP includes a description D1 of the setting application 25 and two badges B1a and B1b. Both badges B1a and B1b represent buttons for downloading and installing the setting application 25 (such badges are also referred to as download badges). The operating system 21 of the terminal device 200 may be various operating systems. The badges B1a and B1b are associated with different operating systems from each other.

Each of the badges B1a and B1b is associated with a link that allows the terminal device to start the store application and display a screen of the settings application in the store application. Various methods may be used to form such badges. For example, a badge may be formed by embedding Hyper Text Markup Language (HTML) code representing the badge into the source code of a web page. The link to be associated with the badge may include, for example, a URL to a product page in the setting application 25. The code for the badge may be obtained in a variety of ways. For example, the system operator providing the operating system may provide a web service to generate the code for the badge. The developer of the setting application 25 may use this web service to obtain the code for the badge. Alternatively, the developer of the setting application 25 may associate a link including instructional information (e.g., a URL scheme) that can be processed by the corresponding operating system to the badge. In either case, the badge may be associated with information (e.g., a link) that includes an identifier of the setting application 25.

In this embodiment, a content of the web page WP provided by the management server 300 is the same regardless of the identification information ui of the link information URL1 and URL2 (FIG. 5A and FIG. 5B).

In S180 (FIG. 2), the user operates the badges B1a and B1b (FIG. 6A), which are associated with the OS 21 of the terminal device 200, via the operation unit 250.

In S185, data representing the link information (in this case, the first link URL1), which is the URL of the web page WP currently displayed on the display 240, is stored in the memory 215 in response to the operation in S180. As described below, the stored link information is later obtained by the setting application 25. Thus, by the process of S185, the link information is provided to the setting application 25. That is, the link information is shared between the browser 23 and the setting application 25.

The architecture for providing the link information to the setting application 25 (and the architecture for sharing the link information between the browser 23 and the setting application 25) may be a variety of architectures. For example, the browser 23 may store the link information as a cookie in the memory 215 (e.g., the non-volatile storage 230). The link information SA in FIG. 1 represents the link information stored in S185 (in this case, the first link URL1). The support page WP (FIG. 6(a)) represented by the link information may include code to store the link information as a cookie. The setting application 25 may obtain the link information by referring the cookie at startup. Alternatively, the operating system 21 or the store application 24 may store the link information in memory 215 (e.g., the non-volatile storage 230). Here, the link information may be stored as a referrer representing the address of the supporting page WP from which the resource is requested, similar to a HTTP header called a referrer. The support page WP represented by the link information may include code to store the link information as a referrer. The setting application 25 may retrieve the link information by referencing the referrer at startup.

As the architecture for providing the link information to the configuration application 25 (hereinafter referred to as the providing architecture), an architecture suitable for the OS21 is adopted. When the OS 21 is “Android”, for example, Google's “Play Install Referrer Library” may be used as the architecture. When the OS21 is “iOS,” for example, a library by a third party different from a provider of an operating system may be used. As such libraries, for example, “Firebase Dynamic Links” by Google, “Unified deep linking” by AppsFlyer, etc. may be used. Such libraries may be compatible with various operating systems, including “Android” as well as “iOS.”

In either case, the link information may be stored in the storage of an external device (e.g., a server not shown) communicable with the terminal device 200, instead of the memory 215 of the terminal device 200.

In S190, the store application 24 is started by the OS21 in response to the operation in S180.

At S200, the store application 24 determines whether the settings application 25 has already been installed. In a case where the settings application 25 has not been installed (S200: No), in S210, the store application 24 displays the settings application 25 screen on the display 240.

FIG. 6B shows an example of the screen displayed in S210. The screen SC2 includes a description D2 of the setting application 25 and the install button B2. The store application 24 may generate the screen SC2 by communicating with the application server 400.

In S220 (FIG. 2), the user operates the install button B2 via the operation unit 250. In S230, data of the setting application 25 is downloaded from the application server 400 according to the operation in S220. in S240, the installation process of the setting application 25 is performed. In S240, the installation process of the setting application 25 is performed. The download process (S230) and the installation process (S240) may be various processes suitable for the OS 21. For example, in S230, the store application 24 downloads the setting application 25 data from the application server 400. In S240, the store application 24 uses the downloaded data to install the setting application 25 on the terminal device 200. The OS 21 adds an icon image of the settings application 25 to the home screen. After S240, the store application 24 performs the process of S250 (FIG. 3).

When the determination result in S200 (FIG. 2) is Yes, the store application 24 skips S210-S240 and moves to S250 (FIG. 3).

In S250, the store application 24 displays the screen of the settings application 25 on the display 240. FIG. 6C shows an example of the screen displayed in S250. The difference from the screen SC2 shown in FIG. 6B is that the install button B2 is replaced by the start button B3 in the screen of FIG. 6C.

In S260 (FIG. 3), the user operates the start button B3 via the operation unit 250. In S270, the settings application 25 is started in response to the operation in S260. The starting of the settings application 25 may be performed by the store application 24 or by the OS 21.

In S280, the setting application 25 obtains the link information (in this case, the first link URL1). The link information is provided to the setting application 25 by the providing architecture described in S185 (FIG. 2). For example, the setting application 25 may obtain the link information by referring a cookie. For referring the cookie, the setting application 25 may use an internal browser embedded in the setting application 25. The setting application 25 may obtain the link information by referring a referrer. The setting application 25 may use a library for the providing architecture. Such libraries may be installed on the terminal device 200 with or in advance of installation of the setting application 25.

In S290, the setting application 25 obtains the identification information ui from the link information obtained in S280 (FIGS. 5A and 5B). Here, the identification information ui is set to “1.”

In S300, the setting application 25 determines whether the identification information ui is provided. The user may install the setting application 25 in various ways. For example, the user can install the setting application 25 on the terminal device 200 by starting the store application 24 without operating the badges B1a or B1b (FIG. 6A). In this case, the link obtained at S280 does not contain a query PQ including the identification information ui. Therefore, the identification information ui is not obtained from the link obtained in S280. That is, the identification information ui is not provided.

When the identification information ui is provided (S300: Yes), in S320, the setting application 25 displays a first setting screen associated with the identification information ui on the display 240.

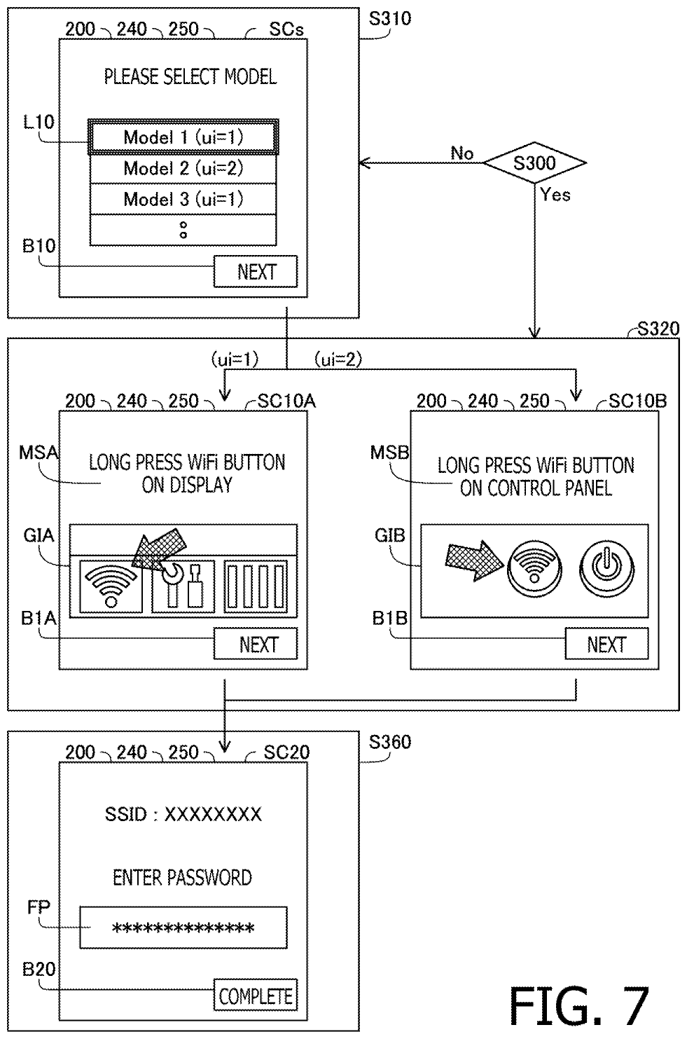

FIG. 7 shows an example of a screen displayed on the display 240. FIG. 7 shows an example of the first setting screen displayed in S320. The setting application 25 displays the screen associated with the identification information ui on the display 240 among two types of first setting screens SC10A and SC10B. The first type of setting screen SC10A is associated with “ui=1” and the second type of setting screen SC10B is associated with “ui=2”. As shown in FIG. 7, the setting screen SC10A includes an explanatory text MSA, an explanatory diagram GIA, and a next button B1A. The setting screen SC10B includes an explanatory text MSB, an explanatory diagram GIB, and a next button B1B. The explanatory texts MSA and MSB and the explanatory diagrams GIA and GIB represent the operation method of the MFP.

In this embodiment, the controller 150A of the “ui=1” model includes a touch screen arranged on the display 140A. The explanatory text MSA and the explanatory diagram GIA on the first type setting screen SC10A represent operation of a particular button (i.e., the operation of the touch screen), which are displayed on the display 140A.

The controller 150B of the “ui=2” model does not include a touch screen, but includes a plurality of physical buttons. The explanatory text MSB and the explanatory diagram GIB in the second type setting screen SC10B represent operation of a particular physical button.

Thus, the operation method of the MFP for setting up differs depending on the model. In this embodiment, the setting application 25 displays a first setting screen (in this example, the first type setting screen SC10A or the second type setting screen SC10B) on the display 240, which represents the method of operation suitable for the model. Here, the first type setting screen SC10A associated with “ui=l” is displayed.

In S330 (FIG. 3), the user operates the MFP with reference to the displayed setting screen. Here, the user operates the touch screen of the first MFP 100A.

In S340, the processor 110A of the MFP 100A performs a SoftAP process in response to the operation of S330. The SoftAP is an abbreviation of “software enabled access point”. The SoftAP is a technology that allows a device different from a router to operate as an access point in a wireless network by software. The processor 110A forms a wireless local area network by controlling the communication interface 180A. The SSID of the SoftAP of the first MFP 100A may be configured in various ways. For example, processor 110A may set a predetermined SSID. The password may be set to a predetermined value or may be omitted.

In S350, the setting application 25 of the terminal device 200 instructs the OS 21 to connect to the local area network formed by the SoftAP. The OS21 connects to the local area network of the SoftAP's according to the instruction. Here, the setting application 25 makes the connection in response to the operation of the next button B1A on the first setting screen in S320 (in this case, the first type setting screen SC10A (FIG. 7)). Alternatively, the setting application 25 may connect the local area network, automatically.

In S360, the setting application 25 displays the second setting screen on the display 240. FIG. 7 shows an example of the second setting screen displayed in S360. The second setting screen SC20 shows an SSID, a password input field FP, and a completion button B20, where SSID is the SSID (in this case, SSIDz) for connecting to the local area network LN formed by the access point 900. The setting application 25 may automatically retrieve the SSIDz from the non-volatile storage 230. Alternatively, the setting application 25 may display a list of SSIDs set in the terminal device 200 on the display 240 and adopt the SSID selected by the user.

In S370, the user inputs the password (in this case, PWz) in the input field FP by operating the operation unit 250 of the terminal device 200. The user then operates the completion button B20 through the operation unit 250.

In S380, the setting application 25 obtains the user instructions (in this case, PWz) input in S370. In S390, the setting application 25 executes a device setting process, which is a process for setting the first MFP 100A, by communicating with the first MFP 100A. In this embodiment, the setting application 25 instructs the OS 21 to transmit data representing the connection information including the SSIDz and PWz. The OS 21 transmits the data representing the connection information to the MFP 100A in accordance with the instruction.

At S400, the processor 110A of the first MFP 100A stores the data of SSIDz and PWz received from the terminal device 200 in non-volatile memory 130A. In S510, the processor 110A terminates the SoftAP and uses information SSIDz and PWz to access the local area network LN.

In S520, the setting application 25 of the terminal device 200 instructs OS21 to terminate the connection with the first MFP 100A and to connect to the local area network LN. The OS21 switches from the connection with the first MFP 100A to the connection with the access point 900 according to the instructions. The setting process is then completed. Thereafter, the terminal device 200 is communicable with the first MFP 100A through the local area network LN (i.e., via the access point 900). The user operates the terminal device 200 to perform various processes, such as printing images, scanning documents, etc., on the first MFP 100A. S520 may be executed prior to S510.

If the identification information ui is not provided in S300 (FIG. 3) (S300: No), in S310, the setting application 25 of the terminal device 200 displays a selection screen SCs on the display 240. FIG. 7 shows an example of the selection screen SCs displayed in S310. The selection screen SCs includes a model name list L10 and a next button B10. Each model name is associated with the identification information ui. In this example, the identification information ui is set to “1” or “2”.

In S315 (FIG. 3), the user selects a model name to be associated with a target MFP (in this case, the first MFP 100A), which is the subject of the setting process, by operating the model name list L10 through the operation unit 250. The user then inputs a selection instruction by operating the next button B10 through the operation unit 250. The setting application 25 of the terminal device 200 determines the identification information ui according to the selection instruction, and proceeds to S320. In S320 and subsequent processes, the identification information ui determined in S315 is used.

The above describes the setting process for the first MFP 100A. The setting process for the second MFP 100B is also performed in the same way as in FIGS. 2 and 3. The differences from the process of the first MFP 100A are as follows. In S150 (FIG. 2), a second link information URL2 (indicated in FIG. 5B) is obtained. The second link URL2 indicates “ui=2.” In S185, the data representing the second link information URL2 is stored in the storage. In S280 (FIG. 3), the setting application 25 obtains the second link information URL2. In S290, the setting application 25 obtains the identification information ui (ui=2). In S320, the setting application 25 displays the second type setting screen SC10B (shown in FIG. 7), which is associated with the identification information ui (ui=2), on the display 240. In S330, the user operates the physical buttons of the second MFP 100B with reference to the second type setting screen SC10B.

The other processes are the same as the corresponding processes in the setting process for the first MFP 100A. For example, the web page displayed on the display 240 in S170 is the same as the web page WP (shown in FIG. 6B) displayed in the setting process for the first MFP 100A.

As described above, in this embodiment, the terminal device 200 (FIG. 1) has the display 240. The processor 210 of the terminal device 200 executes the following process for setting up the target MFP (in this case, the first MFP 100A or the second MFP 100B). The target MFP is an example of a target product that is a product to be processed. In S150 (FIG. 2), the processor 210 obtains the identification information ui related to the target product before the setting application 25 for setting up the target product is installed in the terminal device 200. In 240, the processor 210 installs the setting application 25 in the terminal device 200. In S270, the processor 210 starts the setting application 25 installed in the terminal device 200. In S280, the setting application 25 obtains the link information according to the providing architecture described in S185 (FIG. 2). The link information includes the identification information ui of the target product. Thus, the processor 210 provides the identification information ui to the setting application 25 by the processes S185 and S280.

In S320, the setting application 25 causes the terminal device 200 to perform a function of displaying the setting screen to be associated with the identification information ui on the display 240. As shown in FIG. 7, the setting screen associated with the identification information ui (in this embodiment, the first type setting screen SC10A or the second type setting screen SC10B) indicates operations for setting the target product (in this embodiment, the first MFP 100A or the second MFP 100B). In this embodiment, the operations indicated by the setting screen (also called setting operations) include operations for the target product. In S330, the user performs the setting operation indicated by the setting screen in S320. In S350, S360, S380, and S390, the processor 210 of the terminal device 200 performs processes for setting the target product by the setting operation to set the target product.

According to this configuration, the identification information ui of the target product is obtained before the installation of the setting application 25, and the setting screen corresponding to the identification information ui (in this embodiment, the first type setting screen SC10A or the second type setting screen SC10B) is displayed on the display 240. Thus, guidance to users on the setting operation for setting the target product can be realized. Further, burden on the user for setting the target product is reduced.

In this embodiment, in S200 (FIG. 2), the processor 210 determines whether the setting application 25 has been installed on the terminal device 200. In S240, in a case where the setting application 25 has not been installed on the terminal device 200 (S200: No), the processor 210 installs the setting application 25. Thus, even if the setting application 25 has not been installed on the terminal device 200, the burden on the user for setting the target product is reduced.

In this embodiment, as shown in FIG. 7, the setting application 25 is configured to cause the terminal device 200 to perform the following functions.
(1) S310: The function to display a selection screen SCS (FIG. 7) for selecting a product type (in this case, a model name) on the display 240
(2) S320: The function to display a setting screen (in this case, the first type setting screen SC10A or the second type setting screen SC10B) associated with the selected type on the display 240 (in this embodiment, the setting screen is associated with the identification information ui corresponding to the product type) after displaying the selection screen SCs

As shown in FIG. 3, when the determination result in S300 is Yes, the setting application 25 executes S320 without executing S310. That is, when the identification information ui is provided to the setting application 25 (S300: Yes), the setting application 25 causes the terminal device 200 to execute the function to display the setting screen corresponding to the identification information ui (in this case, the first type setting screen SC10A or the second type setting screen SC10B) on the display 240 without displaying the selection screen SCs on the display 240. In this way, the user's selection of the product type is omitted, and the burden on the user for setting the target product is reduced.

In this embodiment, when the identification information ui is not provided to the setting application 25 (S300: No), the setting application 25 causes the terminal device 200 to perform the function of displaying the selection screen SCs on the display 240 (S310). Thus, even if the identification information ui is not provided to the setting application 25, the terminal device 200 is able to proceed with the setting of the target product.

In this example, as shown in S320 of FIG. 7, the setting application 25 causes the terminal device 200 to perform the function of displaying the first type setting screen SC10A on the display 240 in a case where the identification information ui indicates a first type product (ui=1) and the function of displaying the second type setting screen SC10B on the display 240 in a case where the identification information ui indicates a second type product (ui=2). The function to cause the terminal device 200 to display the second type setting screen SC10B on the display 240 is executed. In this way, the setting application 25 displays the setting screen suitable for the identification information ui on the display 240, so that the burden on the user for setting the target product is reduced. For example, the appropriate operation method may change depending on the identification information ui (e.g., the product type). In such a case, the setting application 25 can display a setting screen on the display 240 indicating the appropriate operation of the target product. The user can easily perform the appropriate operation by referring to the displayed setting screen.

In this embodiment, in S150 (FIG. 2), the processor 210 of the terminal device 200 obtains link information (e.g., first link URL1) indicating the web page WP. As shown in FIGS. 5A and 5B, the link information URL1 and URL2 include the identification information ui. As shown in FIG. 6A, the web page WP includes badges B1a and B1b. The badges B1a and B1b are examples of items indicating installation of the setting application 25. The terminal device 200 (FIG. 1) has a browser 23 that displays the web page WP indicated by the link information on the display 240.

In S180, the user operates an item (in this case, the badge B1a or B1b) included in the web page WP displayed on the display 240. According to this operation, the store application 24 is launched in S190. The store application 24 installs the settings application 25 in S240 in response to the user's instruction in S220. Thus, the processor 210 installs the setting application 25 in the terminal device 200 according to the installation instructions (including processes of S180 and S220) by the user, including the operation of the item at S180.

In S185 (FIG. 2) and S280 (FIG. 3), the processor 210 provides the link information (e.g., the first link URL1) including the identification information ui to the setting application 25 in accordance with the providing architecture described above. As described in S290, the setting application 25 cause the terminal device 200 to execute a function of obtaining the identification information ui from the link information.

According to this configuration, since displaying of the web page WP for the installation of the setting application 25 and providing the identification information ui to the setting application 25 are performed using the link information including the identification information ui, the processor 210 can perform appropriate processes including installation of the setting application 25 and displaying of the setting screen corresponding to the identification information ui by using the link information.

As shown in FIGS. 5A and 5B, the link information URL1 and URL2 are URLs and contain location information PL indicating network locations of the web page and query PQ containing the identification information ui. Such link information URL1 and URL2 can easily realize displaying of the web page WP and providing of the identification information ui.

In this embodiment, the terminal device 200 (FIG. 1) includes a digital camera 255, which is an example of a photographing unit. In S150 (FIG. 2), the processor 210 analyzes the photographed image generated by photographing a code image CI (FIG. 4) with the digital camera 255 to obtain the link information including the identification information ui. Since the user's input of the identification information ui is omitted, the burden on the user for setting the target product is reduced.

In this example, as described in FIGS. 3 and 7, the setting screens (here, the first type setting screen SC10A or the second type setting screen SC10B) show screens for operations for connecting the target product to the access point 900 of the wireless network. Thus, the burden on the user for wireless communication setting of the target product is reduced.

In this embodiment, the setting application 25 stored in the terminal device 200 is a program for the terminal device 200 (i.e., the setting application 25 runs on the terminal device 200). The terminal device 200 has the display 240 and the processor 210, which is an example of a computer. In S170 of FIG. 2, a web page WP shown in FIG. 6A indicated by the link information shown in FIG. 5A and FIG. 5B including the identification information ui of the target product are displayed on the display 240 by the browser 23. In S180, the user operates items (e.g., badges B1a and B1b) included in this web page WP. In response to this operation, the store application 24 is launched in S190. The store application 24 installs the settings application 25 in S240 in response to the user's operation of S220. Thus, the user installs the setting application 25 in the terminal device 200 according to the installation operation including the operations in S180 and S220.

The setting application 25 causes processor 210 to realize the following functions. In S290 of FIG. 3, the setting application 25 causes processor 210 to realize the function of obtaining the identification information ui from the link information shown in FIGS. 5A and 5B when the setting application 25 is started after installation of the setting application 25. In S320, the setting application 25 causes the processor 210 to realize the function of displaying the setting screen corresponding to the identification information ui on the display 240. As shown in FIG. 7, the setting screen (here, the first type setting screen SC10A or the second type setting screen SC10B) that is associated with the identification information ui shows operations for setting the target product (here, the first MFP 100A or the second MFP 100B).

According to this configuration, the link information including the identification information ui associated with the target product is used to install the setting application 25. Then, by displaying the setting screen associated with the identification information ui on the display 240, a setting operation for setting the target product is guided to the user. Thus, the burden on the user for setting the target product is reduced.

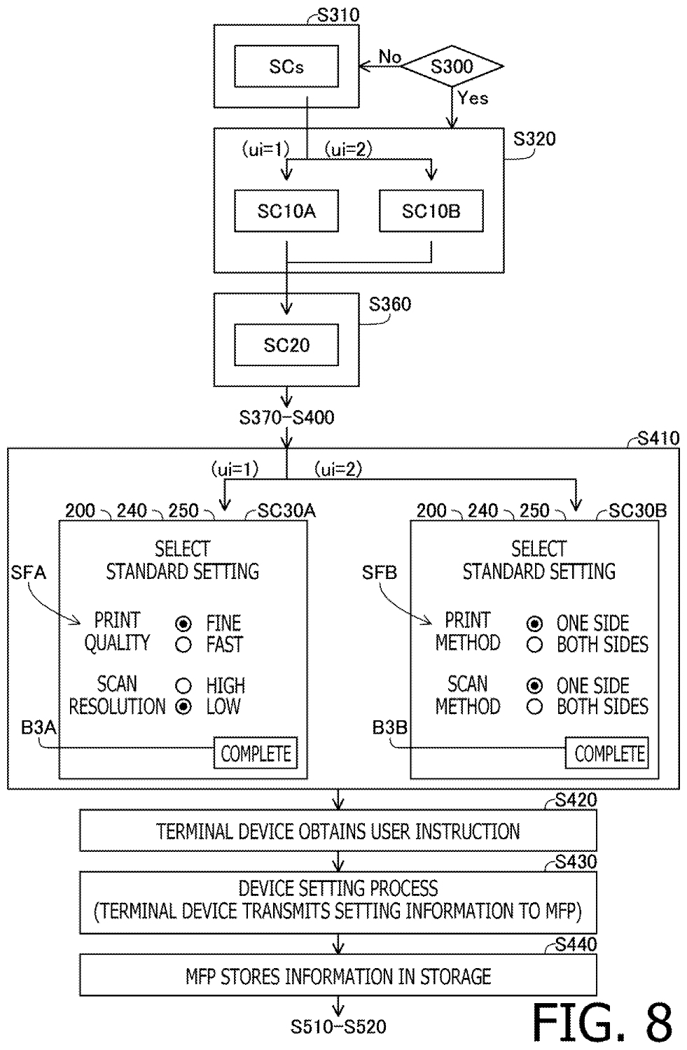

FIG. 8 shows another example of the setting process. Differences from the embodiment explained above are that processes of S410 to S440 are inserted between S400 and S510 in FIG. 3. The other processes of the setting process are the same as those of corresponding parts of the setting process in the embodiment explained above. In FIG. 8, in addition to S410 to S440, a schematic of transition of the screens SCs, SC10A, SC10B, and SC20 in S310, S320, and S360 shown in FIG. 7.

After S400 of FIG. 3, the setting application 25 of the terminal device 200 displays a third setting screen on the display 240 which is associated with the identification information ui in S410. An example of the setting screen is shown in the box indicating S410 in the figure. The setting application 25 displays on the display 240 the screen that is associated with the identification information ui among the two types of third setting screens SC30A and SC30B. The first type of setting screen SC30A is associated with “ui=1” and the second type of setting screen SC30B is associated with “ui=2”. As shown in FIG. 8, the setting screens SC30A and SC30B represent selection areas SFA and SFB for standard operating settings and completion buttons B3A and B3B of the MFPs 100A and 100B, respectively. The standard operating settings are settings used when the user's setting instructions are omitted.

In this embodiment, the selection area SFA for the “ui=1” model represents “print quality” options and “scan resolution” options. The user can select one option for each setting item by operating the operation unit 250 of the terminal device 200.

The selection area SFB for the “ui=2” model represents “print method” options and “scan method” options. The user can select one option for each setting item by operating the operation unit 250 of the terminal device 200.

Thus, the setting items of the standard operating settings differ depending on the model. In this embodiment, the setting application 25 displays a third setting screen (in this case, the first type setting screen SC30A or the second type setting screen SC30B) on the display 240 for setting the appropriate settings for the model.

In S420, the user selects one option for each setting item by operating the operation unit 250 of the terminal device 200. The user then operates the completion button (the completion button B3A or B3B) through the operation unit 250. This causes the setting application 25 to acquire the entered instructions.

In S430, the setting application 25 performs the device setting process, which is a process for setting the target MFP, by communicating with the target MFP. In this embodiment, the setting application 25 transmits data representing options to be selected by the user to the target MFP. In S440, the processor (i.e., the processor 110A or the processor 110B) of the target MFP stores the data of information received from the terminal device 200 in the non-volatile storage (i.e., the non-volatile storage 130A or the non-volatile storage 130B). Then, the processes of S510-S520 are executed, and the setting process is terminated.

As described above, in this embodiment, the setting application 25 causes the terminal device 200 to perform the function of displaying the setting screen that is associated with the identification information ui on the display 240 in S410. As shown in FIG. 8, the setting screen associated with the identification information ui (here, the first type setting screen SC30A or the second type setting screen SC30B) represents a selection area (here, the selection area SFA or the selection area SFB). The selection area is an area for operation of the terminal device 200. That is, the selection area indicates operations for setting the target product. Thus, the setting operation indicated by the setting screen displayed in S410 is an operation for setting the target product and includes an operation of the terminal device 200. In S430, the processor 210 of the terminal device 200 executes processes for setting the target product based on the setting operation.

According to this configuration, the identification information ui of the target product is obtained before the installation of the setting application 25, and the setting screen corresponding to the identification information ui (here, the first type setting screen SC30A or the second type setting screen SC30B) is displayed on the display 240. Thus, guidance to users on the setting operation for setting the target product can be realized. Thus, the burden on the user for setting the target product is reduced.

In this embodiment, as shown in FIG. 8 (S410), the setting application 25 causes the terminal device 200 to perform a function of displaying the first type setting screen SC30A on the display 240 in a case where the identification information ui indicates the first type product (ui=1) and a function of displaying the second type setting screen SC30B in a case where the identification information ui indicates the second type product (ui=2). In a case where the identification information ui indicates the second type product (ui=2), the function to display the second type setting screen SC30B on the display 240 is executed by the terminal device 200. In this way, since the setting application 25 displays a setting screen suitable for the identification information ui on the display 240, the burden on the user for setting the target product is reduced. For example, the settable items may change depending on the identification information ui (e.g., product type). In such a case, the setting application 25 can display a setting screen on the display 240 indicating the appropriate operation of the terminal device 200. The user can easily perform the appropriate operation by referring to the displayed setting screen.

The setting process of this example includes the setting process shown in FIGS. 2 and 3. Therefore, this example also has the same various advantages of the setting process shown in FIGS. 2 and 3.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(1) The code image CI (FIG. 4) representing the identification information ui of the target product may be a one-dimensional barcode or various other code images instead of a QR code. Various methods ui may be used as the obtaining method of the identification information. For example, a sticker representing the code image may be attached to the target product, and in S140 (FIG. 2), the digital camera 255 may photograph this sticker. In this case, the displays (e.g., displays 140A, 140B) may be omitted from the target product. The target product and the terminal device 200 may be equipped with a wireless interface (e.g., a Bluetooth (registered trademark) interface, a near field communication (NFC) interface, etc.) for short-range communication. The terminal device 200 may then obtain the identification information ui from the target product via short-range communication. The management server 300 may also provide a web page representing URLs (e.g., link information URL1, URL2 (FIG. 5(a), FIG. 5(b)) for each target product. The user may browse this web page using the browser 23 of the terminal device 200 and operate the URLs that correspond to the target products. Then, the process proceeds to S160 in FIG. 2. In this case, the digital camera 255 may be omitted from the terminal device 200.

(2) The configuration of the URL including the identification information ui may be various configurations including the identification information ui, instead of the configuration including the location information PL and the query PQ representing the identification information ui (FIGS. 5(a) and 5(b)). For example, the location information PL may include the identification information ui. In this case, the query PQ may be omitted.

(3) The web page WP in FIG. 6(a) includes badges B1a and B1b as items indicating the installation of the setting application 25. The configuration of such items is not limited to badges B1a and B1b, but may be of various configurations, such as text with embedded hyperlinks.

(4) The providing architecture for providing the identification information ui to the setting application 25 is not limited to an architecture that provides link information including the identification information ui to the setting application 25, but may be various architectures. For example, the setting application 25 may be configured to load a predetermined setting file at startup (e.g., S280 (FIG. 3)). The browser 23 may write the identification information ui to the setting file in S185 (FIG. 2). The web page WP (FIG. 6(a)) may contain code to write the identification information ui to the setting file when the badges B1a and B1b are operated. At S185, the browser 23 may transmit the identification information ui to an external server not shown in the figure in S280, the setting application 25 may retrieve the identification information ui from the external server. The providing architecture may comprise a software architecture, a hardware architecture, or both.

(5) The target product settings are not limited to the wireless settings (S360-S400 (FIG. 3)) and the standard operating settings (S410-S440 (FIG. 8)), but may be any settings related to the operation of the target product. For example, S360, S370, S380, S390, and S400 may be omitted from the example shown in FIG. 8. The target product may also transmit or receive e-mails. The setting of the target product may include setting of an email address. Thus, the settings of the target product may include settings of various information used by the target product.

(6) The target product may be set by one or both of the operation of the target product and the operation of the terminal device 200. The operation of the target product may include various operations, e.g., turning on the target product with a specific physical button of the target product pressed, inputting information by operating the controller of the target product, or the like. The operation of the terminal device 200 may include various operations (e.g., long pressing of a particular physical button of the terminal device 200), not limited to inputting information by operating the operation unit 250 (e.g., touch screen). In any case, the setting of the target product may be performed through N operations (N is an integer greater than or equal to 1). The N operations are also referred to as N target operations). The setting operation indicated by the setting screen may include one or more target operations that are part or all of the N target operations. Thus, the setting application 25 may display on the display 240 a setting screen indicating one or more operations that are part or all of the N target operations performed for setting up the target product.

The setting of the target product (i.e., the setting performed by the setting operation) may be a setting performed through one or more operations including the setting operation (i.e., the N target operations including the setting operation). The setting application 25 may display L (L is an integer greater than or equal to 1) setting screens on the display 240 for setting of the target product. The L setting screens may include one or more setting screens that are associated with the identification information ui. The setting screen associated with the identification information ui may indicate the target operation associated with the identification information ui. When L is two or more, the L setting screens may indicate different setting operations from each other. The setting application 25 may display the L setting screens on the display 240 in the order of the setting operations, one by one. In any case, the setting screens may indicate one or both of the operation of the target product and the operation of the terminal device 200. For example, the setting screen displayed in S320 (FIG. 3) may include both the contents of the first type setting screen SC10A (FIG. 7) and the contents of the first type setting screen SC30A (FIG. 8).

(7) The operation of the target product for setting the target product may differ according to the identification information ui. In this case, the operation of the target product indicated by the second type setting screen corresponding to “ui=2” may be different from the operation of the target product indicated by the first type setting screen corresponding to “ui=1”. The operation of the terminal device 200 for setting the target product may be different according to the identification information ui. In this case, the operation of the terminal device 200 indicated by the second type setting screen may be different from the operation of the terminal device 200 indicated by the first type setting screen. For example, the items that can be set for the target product may differ according to the identification information ui. In this case, the selection items shown by the second type setting screen may be different from the selection items shown by the first type setting screen. Also, the usable options for the same setting item may differ according to the identification information ui. In this case, the usable options shown by the second type setting screen may be different from the usable options shown by the first type setting screen.

In either case, the setting application 25 may display the setting screen to be associated with the identification information ui on the display 240 without user instructions after the setting application 25 is started. Instead, the setting application 25 may display the setting screen to be associated with the identification information ui on the display 240 in response to the user's instruction.

(8) The setting application 25 may execute various processes for settings made by the setting operations indicated by the setting screen. The processing for the settings made by the setting operations may include, for example, transmitting to the target product information used by the target product for setting of the target product. The information transmitted may be various information related to the operation of the target product, including but not limited to information on wireless communication settings and standard operating settings. The process for the settings made by the setting operation may be performed by the OS 21 instead of the setting application 25.

(9) The setting process is not limited to the examples in FIG. 2, FIG. 3, FIG. 7, and FIG. 8, but may be various other processes. For example, S200 in FIG. 2 may be omitted. That is, the setting application 25 may be installed regardless of whether or not the setting application 25 has already been installed. The setting application 25 may be started automatically without user instruction (FIG. 3: S260). In addition, S310 and S315 in FIG. 3 may be omitted. When the determination result in S300 is No, the setting application 25 may display information on the display 240 prompting the user to redo the setting process.

(10) The identifying information ui may be a variety of information related to the target product. For example, a plurality of products may be classified into a plurality of series. In this case, the identifying information ui may be information that identifies the series associated with the target product. The plurality of products can be classified into two functional categories, i.e., products having a “wireless setting function using a terminal device” and products not having such a function. In this case, the identification information ui may be information that identifies the functional category to be mapped to the target product.

The identification information ui may be information that identifies a type of error occurred in the target product. Various errors can be employed as errors, such as incorrect wireless settings, paper jam in the printing engine, or the like. The setting screen associated with the identification information ui may indicate operations to resolve the error associated with the identification information ui. The user can easily perform an operation to resolve the error by referring to the displayed setting screen. For example, when an error occurs, the MFP 100A displays a code image representing the identification information ui corresponding to the error on the display 140A. Thereafter, S130 and subsequent processes in FIGS. 2 and 3 are performed. By the processes from S130 to S240, the setting application 25 is installed. By the processes from S250 to S270 (FIG. 3), the setting application 25 is started. By the processes from S280 to S320, the setting application 25 displays a setting screen corresponding to the identification information ui. The setting screen corresponding to the identification information ui is displayed on the display 240. The setting screen indicates operations to resolve the error. For example, when an error in connection with the local area network LN occurs, it is desirable to redo the wireless settings of the MFP 100A. In this case, the same processes as S320 to S520 of the examples in FIGS. 3 and 7 may be performed.

(11) The target product is not limited to a MFP, but may be a variety of products such as a printer, a scanner, a sewing machine, a cutting machine, a machine tool, a digital camera, a smart phone, a tablet computer, a game machine or the like. The terminal device may be a stationary computer (e.g., a desktop computer) as well as a portable terminal such as a smart phone, tablet computer, or the like. In addition, multiple devices (e.g., computers) that can communicate with each other via a network may share some of the functions of the setting process of the terminal device and may provide the functions of the setting process as a whole. In this case, a system with the multiple devices corresponds to a terminal device).

In each of the above examples, a part of the configuration realized by hardware may be replaced with software, or conversely, a part or all of the configuration realized by software may be replaced with hardware. For example, the analysis of the code image in S150 of FIG. 2 may be realized by a dedicated hardware circuit.

When some or all of the functions of the present disclosure are realized in a computer program, the program can be provided in a form stored in a computer-readable recording medium (e.g., a non-transitory recording medium). The program can be used as stored on the same or a different recording medium (computer-readable recording medium) and can be provided. The computer-readable recording media is not limited to portable recording media such as memory cards and CD-ROMs, but can also include internal storages in the computer such as various ROMs, and external storages connected to the computer such as hard disk drives.

The above examples and variations can be combined as appropriate. The above examples and variations are for the purpose of facilitating understanding of the present disclosure, and are not intended to limit the present invention. The invention may be changed and improved without departing from its intent, and the invention includes equivalents thereof.

What is claimed is:

1. A terminal device comprising:
a display; and
a controller configured to perform:
obtaining identification information related to a target product before installing a setting program used to set the target product;
installing the setting program in the terminal device;
starting the setting program installed in the terminal device;
providing the identification information to the setting program;
causing the display to display a setting screen associated with the identification information, the setting screen presenting a setting operation to set the target product, the setting operation indicating one or both of an operation of the target product and an operation of the terminal device; and
setting the target product based on the setting operation.

2. The terminal device according to claim 1,
wherein the controller is further configured to perform:
determining whether the setting program has been installed in the terminal device; and
installing the setting program in the terminal device in response to determining that the setting program has not been installed in the terminal device.

3. The terminal device according to claim 1,
wherein the setting program is configured to cause the terminal device to perform:
displaying a selection screen for selecting a type of a product on the display; and
displaying the setting screen associated with the selected type after displaying the selection screen on the display, and
wherein the setting program is configured to cause the terminal device to perform displaying the setting screen associated with the identification information on the display without displaying the selection screen in a case where the identification information is provided to the setting program.

4. The terminal device according to claim 3,
wherein the setting program is configured to cause the terminal device to perform displaying the selection screen on the display in a case where the identification information is not provided to the setting program.

5. The terminal device according to claim 1,
wherein the setting program is configured to cause the terminal device to perform:
displaying a first type setting screen in a case where the identification information indicates a first type product; and
displaying a second type setting screen in a case where the identification information indicates a second type product.

6. The terminal device according to claim 1,
wherein the controller is configured to perform:
obtaining link information indicating an address of a web page, the link information including the identification information, the web page including an item indicating installation of the setting program,
wherein the terminal device further comprises a browser used to display the web page indicated by the link information on the display,
wherein the controller is further configured to perform:
installing the setting program in the terminal device according to an installation instruction by a user, the installation instruction including an operation of the item included in the web page displayed on the display;
providing the link information including the identification information to the setting program; and
causing the terminal device to perform a function of obtaining the identification information from the link information.

7. The terminal device according to claim 6,
wherein the link information is a Uniform Resource Locator, and
wherein the link information includes location information indicating location of the web page on a network and a query including the identification information.

8. The terminal device according to claim 1, further including a photographing unit,
wherein the controller is further configured to perform obtaining the identification information by analyzing a captured image generated by capturing a code image by the photographing unit.

9. The terminal device according to claim 1,
wherein the setting screen presents the setting operation to connect the target product with an access point in a wireless network.

10. A non-transitory computer-readable recording medium for a terminal device including a display and a controller, the non-transitory computer-readable recording medium containing computer-executable instructions realizing a setting program of the terminal device,
wherein the setting program is configured to be installed in the terminal device according to an installation instruction by a user, the installation instruction including an operation of an item included in a web page displayed on the display, the web page being indicated by link information including identification information related to a target product,
wherein the setting program is configured to, when executed by the controller, cause the terminal device to perform:
obtaining the identification information in response to starting the setting program after installation of the setting program; and
causing the display to display a setting screen associated with the identification information, the setting screen presenting a setting operation to set the target product, the setting operation including one or both of an operation of the target product and an operation of the terminal device.
